(19) United States
(12) Patent Application Publication
(10) Pub. No.: US 2025/0236410 A1
(43) Pub. Date: Jul. 24, 2025

(54) HYDROGEN PROPULSION ASSEMBLY COMPRISING A DEVICE FOR INJECTING INERT GAS, AND AIRCRAFT COMPRISING AT LEAST ONE SUCH PROPULSION ASSEMBLY

(71) Applicant: Airbus Operations SAS, TOULOUSE (FR)

(72) Inventor: Massimiliano DEL GRANO, TOULOUSE (FR)

(21) Appl. No.: 19/028,650

(22) Filed: Jan. 17, 2025

(30) Foreign Application Priority Data
Jan. 19, 2024 (FR) 2400566

(51) Int. Cl. B64D 37/32

(52) U.S. Cl. CPC B64D 37/32; B64D 37/30; F02C 3/22; F02C 7/25; F02C 9/46; B64D 2045/009; F01D 21/04; F01D 21/045; F01D 21/14

(57) ABSTRACT

A propulsion assembly comprising a cowling delimiting an internal zone, an engine which operates on hydrogen, a hydrogen conduit which is connected to the engine and which is positioned in the internal zone, a zone for ejecting debris and an inert gas container which is positioned around or in the vicinity of the hydrogen conduit and which is configured to be perforated or ruptured when it is struck by debris originating from the engine. Also an aircraft comprising at least one such propulsion assembly.

### CROSS-REFERENCES TO RELATED APPLICATIONS

This application claims the benefit of French Patent Application Number 2400566 filed on Jan. 19, 2024, the entire disclosure of which is incorporated herein by way of reference.

### FIELD OF THE INVENTION

The present invention relates to a hydrogen propulsion assembly comprising a device for injecting inert gas and an aircraft comprising at least one such propulsion assembly.

### BACKGROUND OF THE INVENTION

According to one embodiment which is visible in FIG. 1, an aircraft propulsion assembly comprises an engine 10 and a nacelle 12 in which the engine 10 is positioned. This engine comprises a combustion chamber 10.1, a turbine 10.2 and an exhaust 10.3. The propulsion assembly comprises at least one circuit for supplying hydrogen 14 which is configured to conduct hydrogen from a reservoir to the combustion chamber 10.1. The propulsion assembly can also comprise at least one circuit for removing hot air 16, 16′ which is configured to collect hot air in the region of the engine 10 in order to preheat, for example, the air used in the air-conditioning and de-icing systems of the aircraft, and an oil circuit 18 which is configured to cool the oil of the engine 10.

The propulsion assembly comprises at least one zone for ejecting debris 20 which corresponds to a volume in which parts and/or debris ejected from the engine 10 can strike the aircraft in case of faults. The parts and/or debris, which are more or less significant, can originate from different stages of the engine 10.

The circuit for supplying hydrogen 14 comprises at least one hydrogen circuit 22 passing through the zone for ejecting debris 20.

In order to limit the risks of hydrogen leaks, the hydrogen conduit 22 passing through the zone for ejecting debris 20 is a double-walled conduit.

In order to limit the risks of damaging the hydrogen conduit 22, the propulsion assembly comprises at least one shield 24 which is positioned between the engine 10 and the hydrogen conduit 22. This shield 24 is dimensioned to retain debris having energy levels which are lower than a given threshold. However, taking account of the relative limits to its bulk and its weight, this shield 24 cannot retain debris having greater energy levels. As a result, such debris can strike the hydrogen conduit 22 which can generate a hydrogen leak inside the nacelle 12 and lead to an increase in the concentration of hydrogen and pressure in the nacelle 12.

The propulsion assembly can also comprise at least one fire extinguishing system 26 which makes it possible to extinguish a fire outbreak rapidly.

In order to limit the increase in pressure inside the nacelle 12, the propulsion assembly comprises at least one pressure relief panel 26 which is configured to open automatically as soon as the pressure inside the nacelle 12 exceeds a trigger threshold and to place the inside and the outside of the nacelle 12 in communication with one another. The propulsion assembly can comprise two pressure relief panels 26, 26′ which make it possible to obtain ventilation inside the nacelle 12, which contributes to reducing the concentration of hydrogen inside the nacelle 12.

The ventilation of the inside of the nacelle is not optimal since the triggering thereof is delayed and only takes place when the pressure inside the nacelle exceeds the trigger threshold.

The present invention aims to remedy all or some of the drawbacks of the prior art.

### SUMMARY OF THE INVENTION

To this end, the subject of the invention is a propulsion assembly comprising a cowling separating an internal zone and an external zone, an engine which is positioned in the internal zone, a zone for ejecting debris which is at least partially positioned in the internal zone and into which debris originating from the engine can be ejected, and a system for supplying hydrogen comprising at least one hydrogen conduit passing through the zone for ejecting debris.

According to the invention, the propulsion assembly comprises a device for injecting inert gas comprising an inert gas container which contains at least one pressurized inert gas, said inert gas container being at least partially positioned in the zone for ejecting debris, around or in the vicinity of the hydrogen conduit, and being configured to be perforated or ruptured when the inert gas container is struck by debris originating from the engine.

According to the invention, when debris ejected from the engine generates a leak in the region of the hydrogen conduit, it additionally and simultaneously generates a leak in the region of the inert gas container. The inert gas exiting from the inert gas container and injected into the internal zone makes it possible to obtain a dilution of the hydrogen in the internal zone and prevents the concentration of hydrogen and/or oxygen in the internal zone from reaching a critical threshold.

According to a further feature, the inert gas container has a resistance to perforation or rupture which is less than that of the hydrogen conduit.

According to a further feature, the inert gas contained in the inert gas container has a temperature of less than 20° C.

According to a further feature, the inert gas container comprises at least one inert gas conduit which has a section juxtaposed with the hydrogen conduit.

According to a further feature, the section of the inert gas conduit is positioned between the engine and the hydrogen conduit.

According to a further feature, the inert gas container comprises at least one inert gas conduit which has a section in which the hydrogen conduit is at least partially inserted.

According to a further feature, the propulsion assembly comprises at least one shield which is positioned between, on the one hand, the engine and, on the other hand, the hydrogen conduit and the section of the inert gas conduit.

According to a further feature, the system for supplying hydrogen comprises a shut-off valve which is configured to occupy on and blocked states, the propulsion assembly comprising a control system in order to control the state of the shut-off valve and at least one first system for detecting leaks which is configured to provide information to the control system in order to control the state of the shut-off valve.

According to a further feature, the first system for detecting leaks comprises at least one element which is selected from at least one pressure sensor which is configured to measure the pressure in the internal zone, at least one pressure sensor which is configured to measure the pressure of the inert gas in the inert gas container and at least one wire break detector which is positioned along the hydrogen conduit.

According to a further feature, the first wire break detector comprises a wire passing along the hydrogen conduit, the propulsion assembly comprising a shield which is positioned between the engine and the wire of the first wire break detector.

According to a further feature, the inert gas container comprises a trigger valve which is configured to occupy a first state in which the trigger valve enables an injection of inert gas into the internal zone and a second state in which the trigger valve prevents any flow of inert gas into the internal zone. In addition, the device for injecting inert gas comprises a control system for controlling the state of the trigger valve and a second system for detecting leaks which is configured to detect a leak in the region of the engine and to provide information to the control system of the trigger valve in order to control the state thereof.

According to a further feature, the propulsion assembly comprises a shield. In addition, the second system for detecting leaks comprises at least one second wire break detector, comprising at least one wire positioned between the engine and the shield.

A further subject of the invention is an aircraft comprising at least one propulsion assembly according to one of the preceding features.

### BRIEF DESCRIPTION OF THE DRAWINGS

Further features and advantages will become apparent from the following description of the invention, the description being provided solely by way of example and with reference to the accompanying drawings, in which:

FIG. 1 is a schematic longitudinal section of a propulsion assembly illustrating an embodiment of the prior art,

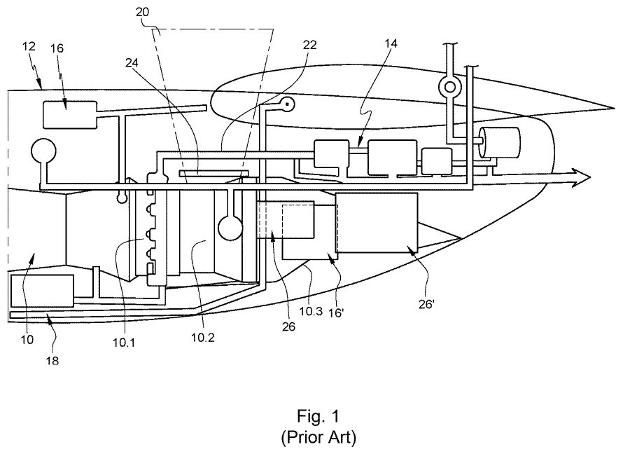

FIG. 2 is a schematic longitudinal section of a propulsion assembly illustrating an embodiment of the invention,

FIG. 3 is a schematic longitudinal section of a propulsion assembly illustrating a further embodiment of the invention,

FIG. 4 is a schematic longitudinal section of a propulsion assembly illustrating a further embodiment of the invention.

### DETAILED DESCRIPTION OF THE PREFERRED EMBODIMENTS

According to one configuration, an aircraft comprises at least one propulsion assembly 30 operating on the basis of hydrogen.

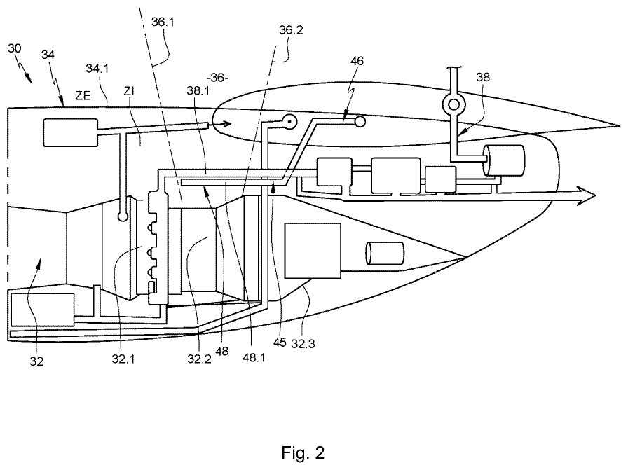

According to the embodiments which are visible in FIGS. 2 to 4, a propulsion assembly 30 comprises an engine 32 which operates on the basis of hydrogen and a nacelle 34 in which the engine 32 is positioned.

According to one configuration, the engine 32 comprises a combustion chamber 32.1, a turbine 32.2, an exhaust 32.3 and a casing 32.4 forming an envelope in which the majority of the elements of the engine 32 are positioned. The nacelle 34 comprises a cowling 34.1 separating an internal zone ZI in which the engine 32 is positioned and an external zone ZE.

The propulsion assembly 30 comprises at least one zone for ejecting debris 36, which is at least partially positioned in the internal zone ZI into which debris originating from the engine 32 can be ejected in the case of faults. According to one arrangement, this zone for ejecting debris 36 is positioned around the turbine 32.2. It extends between an upstream boundary 36.1 and a downstream boundary 36.2, the terms “upstream” and “downstream” referring to a direction of flow of the gases in the engine 32. Naturally, the invention is not limited to this arrangement for the zone for ejecting debris 36.

The propulsion assembly 30 comprises at least one system for supplying hydrogen 38 which is configured to conduct hydrogen from at least one reservoir to the engine 32. This system for supplying hydrogen 38 comprises at least one hydrogen conduit 38.1 in which the hydrogen circulates, passing through the zone for ejecting debris 36. According to one configuration, the hydrogen conduit 38.1 is a double-walled conduit. According to one arrangement, the hydrogen conduit 38.1 passes through the upstream and downstream boundaries 36.1, 36.2 of the zone for ejecting debris 36.

The engine 32, the nacelle 34 and the system for supplying hydrogen 38 are not described in more detail since they can be identical to those of the prior art.

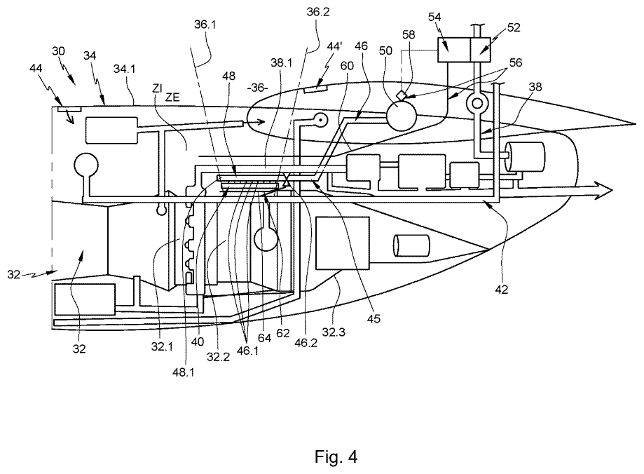

According to one embodiment which is visible in FIG. 4, in order to limit the risks of damage to the hydrogen conduit 38.1, the propulsion assembly 30 comprises at least one shield 40 which is positioned between the engine 32 and the hydrogen conduit 38.1 and which is configured to retain at least debris having an energy level which is lower than a given threshold. This shield 40 is not described in more detail since it can be identical to those of the prior art.

According to one embodiment which is visible in FIG. 4, the propulsion assembly 30 comprises at least one fire extinguishing system 42. This fire extinguishing system 42 is not described in more detail since it can be identical to those of the prior art.

According to one configuration which is visible in FIG. 4, the propulsion assembly 30 comprises at least one pressure relief panel 44 which is configured to open automatically as soon as the pressure in the internal zone ZI of the nacelle 34 exceeds a trigger threshold and to place the internal zone ZI and the external zone ZE of the nacelle in communication with one another. In the event of a rupture or perforation of the hydrogen conduit 38.1, each pressure relief panel 44 makes it possible to avoid the situation where the pressure in the internal zone ZI of the nacelle 34 exceeds a given threshold, thus limiting the risks of excess pressure of the nacelle 34.

According to one arrangement, the propulsion assembly 30 comprises at least first and second pressure relief panels 44, 44′, positioned on either side of the zone for ejecting debris 36. Thus the first pressure relief panel 44 is positioned upstream of the zone for ejecting debris 36 and the second pressure relief panel 44′ is positioned downstream of the zone for ejecting debris 36. This arrangement promotes the ventilation of the internal zone ZI, in particular the part of the internal zone ZI in which the zone for ejecting debris 36 is located. As soon as they are opened, the first and second pressure relief panels 44, 44′ enable the pressure and the concentration of hydrogen in the internal zone ZI to be limited.

The propulsion assembly 30 comprises a device for injecting inert gas 45 which comprises an inert gas container 46, which contains at least one inert gas and which is positioned at least partially in the zone for ejecting debris 36 and in the vicinity of the hydrogen conduit 38.1, the inert gas container 46 being configured to be perforated or ruptured when it is struck by debris originating from the engine 32. According to one configuration, the inert gas container 46 has a resistance to perforation or rupture which is less than that of the hydrogen conduit 38.1.

As a result, when debris generates a leak in the region of the hydrogen conduit 38.1, it additionally and simultaneously generates a leak in the region of the inert gas container 46 positioned to the side of the hydrogen conduit 38.1. The hydrogen and the inert gas respectively contained in the hydrogen conduit 38.1 and the inert gas container 46 are thus propagated in the internal zone ZI. The inert gas exiting from the inert gas container 46 and injected into the internal zone ZI makes it possible to obtain a dilution of the hydrogen in the internal zone ZI and prevents the concentration of hydrogen in the internal zone ZI from reaching a critical threshold.

The inert gas container 46 contains at least one pressurized inert gas. For the remainder of the description, an inert gas or the inert gas is understood to be a single inert gas or a mixture of inert gases.

The inert gas can be nitrogen gas or helium. Naturally the invention is not limited to these gases for the inert gas.

The inert gas contained in the inert gas container 46 has a temperature of less than 20° C.

According to the embodiments which are visible in FIGS. 2 and 4, the inert gas container 46 comprises at least one inert gas conduit 48 which has a section 48.1 juxtaposed with the hydrogen conduit 38.1. According to one arrangement, the section 48.1 of the inert gas conduit 48 is positioned between the engine 32 and the hydrogen conduit 38.1. In the presence of a shield 40, the section 48.1 of the inert gas conduit 48 is positioned between the shield 40 and the hydrogen conduit 38.1. According to one arrangement, the section 48.1 of the inert gas conduit 48 extends approximately from the upstream boundary 36.1 to the downstream boundary 36.2 of the zone for ejecting debris 36 and is positioned in the same angular sector as the hydrogen conduit 38.1.

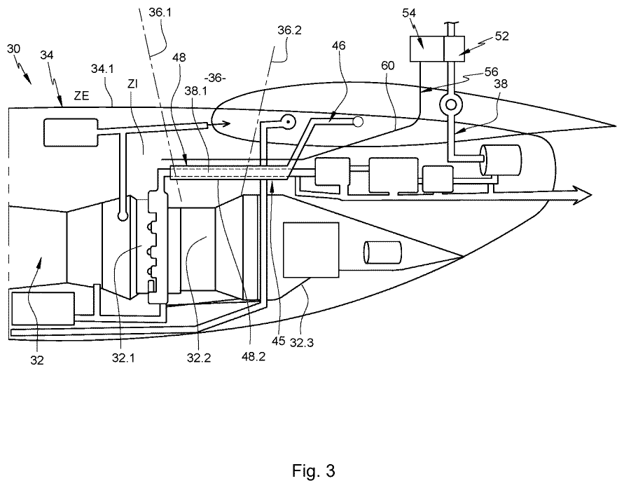

According to a further embodiment which is visible in FIG. 3, the inert gas conduit 48 has a section 48.2 which is positioned around the hydrogen conduit 38.1 which, as a result, is at least partially inserted into the section 48.2. According to this embodiment, the annular section 48.2 and the hydrogen conduit 38.1 are substantially coaxial. During operation, the debris strikes the annular section 48.2 before striking the hydrogen conduit 38.1.

According to a configuration which is visible in FIG. 4, the inert gas container 46 comprises at least one pressurized inert gas reservoir 50 which is connected to the inert gas conduit 48. This configuration makes it possible to inject a significant volume of inert gas in the case of leaks.

According to the embodiments which are visible in FIGS. 3 and 4, the system for supplying hydrogen 38 comprises a shut-off valve 52, a so-called FSOV valve (fuel shut-off valve), which is configured to occupy an on state in which the shut-off valve 52 permits a flow of hydrogen in the direction of the engine 32 and a blocked state in which the shut-off valve 52 prevents any flow of hydrogen in the direction of the engine 32. This shut-off valve 52 is positioned in the external zone ZE of the nacelle 34 (outside the nacelle 34) in order to block any flow of hydrogen in the direction of the internal zone ZI in the blocked state. In addition, the propulsion assembly 30 comprises a control system 54 which is configured to control the state of the shut-off valve 52 and at least one first system for detecting leaks 56, comprising at least one element which is selected from at least one pressure sensor which is configured to measure the pressure in the internal zone ZI and which is positioned in the vicinity of the hydrogen conduit 38.1, at least one pressure sensor 58 which is configured to measure the pressure of the inert gas in the inert gas container 46 and at least one wire break detector 60, the first system for detecting leaks 56 being configured to detect a leak of hydrogen and to provide information to the control system 54 in order to control the state of the shut-off valve 52.

According to one embodiment which is visible in FIG. 3, the first system for detecting leaks 56 comprises a first wire break detector 60 which comprises a wire positioned along the hydrogen conduit 38.1. The wire of the first wire break detector 60 extends at least from the upstream boundary 36.1 to the downstream boundary 36.2 of the zone for ejecting debris 36.

According to a further embodiment which is visible in FIG. 4, the first system for detecting leaks 56 comprises a first wire break detector 60, which comprises a wire positioned along the hydrogen conduit 38.1, and a pressure sensor 58 which is configured to measure the pressure of the inert gas in the reservoir 50 of the inert gas container 46.

According to these two embodiments, the wire of the first wire break detector 60, which passes along the hydrogen conduit 38.1, is further removed from the engine 32 than the shield 40. Thus this shield is positioned between the engine 32 and the wire of the first wire break detector 60.

Naturally the invention is not limited to these embodiments for the first system for detecting leaks. Thus other sensors or other combinations of sensors are conceivable.

According to one embodiment which is visible in FIG. 4, the inert gas container 46 comprises at least one exhaust 46.1 and a trigger valve 46.2 which is configured to occupy a first state in which the trigger valve 46.2 permits the injection of inert gas via the exhaust 46.1 into the internal zone ZI and a second state in which the trigger valve 46.2 prevents any flow of inert gas via the exhaust 46.1 into the internal zone ZI. In addition, the device for injecting inert gas 45 comprises a control system for controlling the state of the trigger valve 46.2 and a second system for detecting leaks 62 which is configured to detect a leak in the region of the casing 32.4 of the engine 32 and to provide information to the control system of the trigger valve 46.2 in order to control the state thereof.

According to one configuration, the second system for detecting leaks 62 comprises at least one second wire break detector 64 which comprises at least one wire which is positioned in the zone for ejecting debris 36. According to one arrangement, the wire of the second wire break detector 64 extends at least from the upstream boundary 36.1 to the downstream boundary 36.2 of the zone for ejecting debris 36. According to a further embodiment, the wire of the second wire break detector 64 is positioned between the engine 32 and the shield 40.

Thus, according to the embodiment which is visible in FIG. 4, the propulsion assembly 30 comprises a first wire break detector 60 in order to control the state of the shut-off valve 52 of the system for supplying hydrogen 38 and a second wire break detector 64 in order to control the state of the trigger valve 46.2 of the device for injecting inert gas 45.

During operation, when debris having low energy levels perforate the casing 32.4 of the engine 32, they are retained by the shield 40 and do not perforate the hydrogen conduit 38.1. However, hot gases can exit from the engine 32. The debris ejected from the engine 32, having perforated the casing 32.4 thereof, cuts the wire of the second wire break detector 64 causing the opening of the trigger valve 46.2 and the injection of cold inert gas into the internal zone ZI, thus limiting the increase in temperature of the gaseous mixture in this internal zone ZI.

If debris having high energy levels are ejected from the engine 32, they can pass through the shield 40, strike the hydrogen conduit 38.1 and possibly perforate the cowling 34.1 of the nacelle 34.

Whatever the flight phase, the flow rate of hydrogen in the hydrogen conduit 38.1 is such that it leads in theory to a rapid filling of the internal zone ZI in the case of leaks in the region of the hydrogen conduit 38.1. Taking account of its position in the vicinity of the hydrogen conduit 38.1, the inert gas container 46 is perforated or ruptured simultaneously with the inert gas conduit 38.1, which leads to the injection of an inert gas into the internal zone ZI.

The injection of cold inert gas results in limiting the increase in the temperature of the gaseous mixture present in the internal zone ZI and the concentration of hydrogen in the internal zone ZI, which does not reach a critical concentration. Due to this injection of inert gas, the internal zone ZI is saturated with inert gas and contains a gaseous environment which is rich in hydrogen and inert gas having a low quantity of oxygen.

The injection of inert gas into the internal zone ZI at the same time as that of hydrogen leads to a more rapid increase in the pressure in the internal zone ZI and thus to a more rapid opening of the pressure relief panel(s) 44, 44′, leading to a ventilation of said internal zone ZI.

In addition to the rupture of the hydrogen conduit 38.1 and the inert gas conduit 48, the debris ejected by the engine 32 cuts the wire of the first wire break detector 60 which causes the closure of the shut-off valve 52. At the same time, the pressure sensor 58 detects the drop in pressure of the inert gas and also causes the closure of the shut-off valve 52. This redundancy enhances the safety.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion assembly comprising:
a cowling separating an internal zone and an external zone;
an engine positioned in the internal zone;
a zone for ejecting debris at least partially positioned in the internal zone and into which debris originating from the engine is ejected;
a system for supplying hydrogen comprising at least one hydrogen conduit passing through the zone for ejecting debris; and,
a device for injecting inert gas comprising an inert gas container containing at least one pressurized inert gas, said inert gas container being at least partially in the zone for ejecting debris, proximate the at least one hydrogen conduit, and said device for injecting inert gas being configured to be perforated or ruptured when the inert gas container is struck by debris originating from the engine.

2. The propulsion assembly according to claim 1, wherein the inert gas container has a resistance to perforation or rupture which is less than a resistance to perforation or rupture of the at least one hydrogen conduit.

3. The propulsion assembly according to claim 1, wherein the inert gas contained in the inert gas container has a temperature of less than 20° C.

4. The propulsion assembly according to claim 1, wherein the inert gas container comprises at least one inert gas conduit which has a section juxtaposed with the at least one hydrogen conduit.

5. The propulsion assembly according to claim 4, wherein the section of the inert gas conduit is positioned between the engine and the at least one hydrogen conduit.

6. The propulsion assembly according to claim 4, wherein the propulsion assembly comprises at least one shield positioned between, on one hand, the engine and, on another hand, the at least one hydrogen conduit and the section of the inert gas conduit.

7. The propulsion assembly according to claim 1, wherein the inert gas container comprises at least one inert gas conduit which has a section in which the at least one hydrogen conduit is at least partially inserted.

8. The propulsion assembly according to claim 1, wherein the system for supplying hydrogen comprises a shut-off valve configured to occupy an on state and a blocked state, and
wherein the propulsion assembly further comprises:
a control system configured to control a state of the shut-off valve; and, at least one first system for detecting leaks which is configured to detect a leak of hydrogen and to provide information to the control system for controlling the state of the shut-off valve.

9. The propulsion assembly according to claim 8, wherein the first system for detecting leaks comprises at least one element selected from a group consisting of: at least one pressure sensor configured to measure a pressure in the internal zone; at least one pressure sensor configured to measure a pressure of the inert gas in the inert gas container;
and, at least one wire break detector positioned along the at least one hydrogen conduit.

10. The propulsion assembly according to claim 9, wherein the at least one wire break detector comprises a wire passing along the at least one hydrogen conduit, and wherein the propulsion assembly further comprises:
a shield positioned between the engine and the wire of the at least one wire break detector.

11. The propulsion assembly according to claim 1, wherein the inert gas container comprises a trigger valve configured to occupy a first state in which the trigger valve enables an injection of inert gas into the internal zone and a second state in which the trigger valve prevents any flow of inert gas into the internal zone, and wherein the device for injecting the inert gas comprises a control system configured to control a state of the trigger valve and a system for detecting leaks which is configured to detect a leak in a region of the engine and to provide information to the control system for controlling the state of the trigger valve.

12. The propulsion assembly according to claim 11, wherein the propulsion assembly further comprises:
a shield, and
wherein the system for detecting leaks comprises at least one wire break detector comprising at least one wire positioned between the engine and the shield.

13. An aircraft comprising:
the propulsion assembly according to claim 1.
